(19) United States
(12) Patent Application Publication
(10) Pub. No.: US 2026/0297273 A1
(43) Pub. Date: Oct. 1, 2026

(54) PRODUCTION OF COMPOSITE MATERIAL WITH A LOW COMPOSITE POROSITY FRACTION

(71) Applicant: LUXEMBOURG INSTITUTE OF SCIENCE AND TECHNOLOGY (LIST), ESCH-SUR-ALZETTE (LU)

(72) Inventor: Frédéric ADDIEGO, Esch-sur-Alzette (LU)

(21) Appl. No.: 19/477,618

(22) PCT Filed: Apr. 25, 2024
(86) PCT No.: PCT/EP2024/061344

§ 371 Date: Oct. 22, 2025

(30) Foreign Application Priority Data
Apr. 26, 2023 (LU) LU504081

(51) Int. Cl. C08J 5/24

(52) U.S. Cl. CPC C08J 5/248; C08J 2333/04; C08J 2379/02; C08J 2401/02

(57) ABSTRACT

The disclosure concerns a method for producing a composite material comprising a polymer matrix and at least one natural fibres material, said method is remarkable in that it comprises the steps of (a) providing one or more natural fibres materials; (b) applying an adhesive compound onto said one or more natural fibres materials under polymerization conditions to form one or more adhesive-treated natural fibres materials; (d) providing a polymer matrix; and (e) manufacturing a composite material with said polymer matrix and said one or more adhesive-treated natural fibres materials; wherein step (b) comprises providing an aqueous solution of one or more precursors of adhesive compound and at least one polyelectrolyte, and dipping the one or more natural fibres materials into said aqueous solution. The disclosure also relates to a composite material having a composite porosity fraction of at most 0.080%.

### TECHNICAL FIELD

The present disclosure relates to a method for producing a composite material comprising a polymer matrix and one or more natural fibres materials, a composite material thereof, and the use of such composite material.

### TECHNICAL BACKGROUND

Green composite materials have become highly attractive since the incorporation of natural fibre materials provides not only interesting properties for the composites but also alleviates ecological concerns that may arise. For example, green composite materials can be more easily recycled and are in general less harmful to the ecosystems. However, at the interphase between the natural fibres materials and the polymer's matrix of the composites, it subsists a porosity that provokes a bad adhesion between the green reinforcement materials and the polymer matrix. Such weakness renders the green composite materials brittle so there is a need for improvement.

Such fragility is indeed detrimental. For example, the study of Öktem M. F., et al., entitled “Development of flame retardant shape memory polymer flax fiber composite by using organic polydopamine coating and nanoparticles” (Arab. J. Sci. Eng., 2022, 47, 6461-6475) has revealed that it is possible to slow down the flame propagation rate in a polymer composite reinforced with flax fibres, wherein the flax fibres are treated with diammonium phosphate (DAP), polydopamine (PDA) and TiO₂. DAP was used here as one additive to improve the flame retardancy of the natural fibre composite. To prepare the composite, the flax fibre fabric was rinsed to improve the quality of the PDA coating. The study has shown that the composite with PDA-coated fibres already improves the flame retardancy and subsequently the integrity of the composite, but that this effect is further improved when nanoparticles of TiO₂ were incorporated into the polymer matrix.

On the other hand, concerns are increasingly arousing about the widespread use of nanoparticles in general, as expressed in a study by Fiordaliso F., et al., entitled “Toxicological impact of titanium dioxide nanoparticles and food-grade titanium dioxide (E171) on human and environmental health” (Environ. Sci.: Nano, 2022, 9, 1199-1211). It would be therefore desirable to develop a method for avoiding the use of nanoparticles in the production of less-brittle or even non-brittle green composite material.

The objective of this disclosure is therefore to provide a method for producing green composite material with enhanced resistance without employing nanoparticles.

### SUMMARY

According to a first aspect, the disclosure relates to a method for producing a composite material comprising a polymer matrix and one or more natural fibres materials, said method is remarkable in that it comprises the following steps:
a) providing one or more natural fibres materials;
b) applying an adhesive compound onto said one or more natural fibres materials under polymerization conditions to form one or more adhesive-treated natural fibres materials;
c) optionally washing and/or drying said one or more adhesive-treated natural fibres materials;
d) providing a polymer matrix; and
e) manufacturing a composite material with said polymer matrix and said one or more adhesive-treated natural fibres materials;
wherein step (b) comprises providing an aqueous solution of one or more precursors of the adhesive compound and at least one polyelectrolyte, and dipping the one or more natural fibres materials into said aqueous solution.

Surprisingly, it was found that the use of at least one polyelectrolyte disturbs the polymerisation of one or more precursors of the adhesive compound on the natural fibres materials. The presence of one or more polyelectrolytes during the polymerization of the one or more precursors of the adhesive compound provides a grainy structure of the adhesive compound. Such grainy structure, which is adhesive, is coated on the one or more natural fibres materials, which subsequently reduces the degree of porosity when these one or more adhesive-treated natural fibres materials are incorporated into a polymer matrix to form a composite material. The reduction of porosity in such composite material improves its integrity and does not thus require the incorporation of nanoparticles in the polymeric matrix, which is beneficial for environmental reasons.

More particulary, the disclosure relates to a method for producing a composite material comprising a polymer matrix and one or more natural fibres materials, said method is remarkable in that it comprises the following steps:
a) providing one or more natural fibres materials;
b) applying an adhesive compound onto said one or more natural fibres materials under polymerization conditions to form one or more adhesive-treated natural fibres materials;
c) optionally washing and/or drying said one or more adhesive-treated natural fibres materials;
d) providing a polymer matrix; and
e) manufacturing a composite material with said polymer matrix and said one or more adhesive-treated natural fibres materials;
   wherein step (b) comprises providing an aqueous solution of one or more precursors of the adhesive compound and at least one polyelectrolyte, and dipping the one or more natural fibres materials into said aqueous solution and wherein the method further comprises the step of cleaning the one or more natural fibres materials provided at step (a) before step (b) with a basic solution.

Surprisingly, the step of cleaning with a basic solution before treating with the one or more adhesive compounds and the one or more polyelectrolytes allows the removal of hemicellulose and lignin from the one or more natural fibres materials, and allows the creation of a finer crystalline structure of the cellulose which strengthens the adhesion of the grainy adhesive structure made of the one or more polyelectrolytes and the one or more polymerized precursors of the adhesive compound. This strengthening further contributes to the reduction of the porosity between the polymer matrix and the one or more natural fibres materials, further improving the integrity of the composite material.

The Application of an Adhesive Compound onto Said One or More Natural Fibres Materials

For example, one or more of the following features further define the step (b):
The polymerization conditions of step (b) comprise a pH ranging between 8.0 and 9.0, preferably ranging between 8.0 and 8.7, or between 8.0 and 8.5.
The polymerization conditions of step (b) comprise a concentration of the one or more precursors of adhesive compound ranging between 0.5 g/L and 7.0 g/L of the aqueous solution, preferably between 0.5 g/L and 3.0 g/L, more preferably between 0.5 g/L and 2.5 g/L, even more preferably between 1.0 g/L and 2.5 g/L.
The polymerization conditions of step (b) comprise a temperature ranging between 15° C. and 90° C., preferably between 20° C. and 85° C., more preferably between 25° C. and 80° C.
Step (b) is performed during a time ranging between 10 minutes and 10 hours, or between 15 minutes and 9 hours.
Step (b) is performed in presence of an oxidant. For example, the oxidant is one or more selected from air, oxygen, CuSO₄, sodium periodate, ammonium peroxodisulfate or a mixture thereof.
Step (b) is performed under stirring conditions.
The method further comprises the step of drying the one or more natural fibres materials before step (b).

### The One or More Polyelectrolytes

For example, the one or more polyelectrolytes are selected from the group comprising poly(ethylene)imine, poly(acrylic acid), poly(methacrylic acid), poly(allylamine hydrochloride), poly(acrylamide-2-methyl-propane sulfonate), poly(3-sulfopropyl methacrylate), poly(styrene sulfonate), poly(N—N—N-trimethyl-2-methacryloyl ethyl ammonium bromide), poly(vinyl sulphate), poly(diallyl dimethylammonium chloride), poly(4-vinyl-N-methylpridinium iodide), sulfonated-polyetherketone, sulfonated-polyetheretherketone, sulfonated-polyetheretherketoneketon, esulfonated-polyetherketoneketone, sulfonated polyetherketoneetherketoneketone, or a mixture thereof. With preference, one polyelectrolyte is poly(ethylene)imine.

Advantageously, the concentration of the one or more polyectrolytes is ranging between 0.50 and 5.0 g/L, preferably between 0.75 g/L and 3.0 g/L of the aqueous solution, more preferably between 0.75 g/L and 2.0 g/l, even more preferably between 0.75 g/L and 1.5 g/L.

Advantageously, the one or more polyelectrolytes are present in said aqueous solution so that the ratio between the one or more precurosrs of an adhesive compound and the one or more polyelectrolytes is raning between 1.0 and 3.0, preferably between 1.5 and 2.5.

Advantageously, the one or more polyelectrolytes have a molecular weight ranging between 300 g/mol and 1500 g/mol; preferably, between 350 g/mol and 900 g/mol; more preferably, between 400 g/mol and 800 g/mol; even more preferably, between 450 g/mol and 750 g/mol; and most preferably, between 500 g/mol and 700 g/mol.

### Cleaning Step

Advantageously, the method further comprises the step of cleaning the one or more natural fibres materials provided at step (a) before step (b) with a basic solution.

The step of cleaning the one or more natural fibres materials with a basic solution before treating them with the one or more adhesive compounds and the one or more polyelectrolytes allows the removal of hemicellulose and lignin from the one or more natural fibres materials, and allows the creation of a finer crystalline structure of the cellulose which strengthens the adhesion of the grainy adhesive structure made of the one or more polyelectrolytes and the one or more polymerized precursors of the adhesive compound. This strengthening further contributes to the reduction of the porosity between the polymer matrix and the one or more natural fibres materials, further improving the integrity of the composite material.

For example, the step of cleaning is performed by dipping the one or more natural fibres materials into the basic solution.

With preference, the dipping is performed for a time ranging between 1 hour and 4 hours, or between 1.5 hours and 3.5 hours.

With preference, the dipping is performed at a temperature ranging between 15° C. and 30° C., or between 20° C. and 25° C.

With preference, the step of cleaning is a mercerisation step made in accordance with ASTM D1695.

For example, the basic solution has a pH of at least 10.0, or preferably of at least 10.5, or more preferably of at least 11.0. For example, the basic solution has a pH ranging between 10.0 and 14.0, preferably between 10.5 and 13.5, or between 11.0 and 13.0.

For example, the basic solution comprises one or more alkali agents at a concentration ranging between 0.25 wt. % and 30.00 wt. % of the total weight of the basic solution, preferably between 0.50 wt. % and 25.00 wt. %, more preferably between 0.75 wt. % and 20.00 wt. %, even more preferably between 1.00 wt. % and 15.00 wt. %.

For example, the basic solution comprises one or more alkali agents selected from NaOH, KOH, LiOH, Ca(OH)₂, NH₄OH, or a mixture thereof, preferably one alkali agent is NaOH.

With preference, the method further comprises the step of drying the one or more natural fibres materials after the cleaning step and before step (b).

### The One or More Precursors of Adhesive Compound

Advantageously, the one or more precursors of the adhesive compound are selected from the group comprising one or more precursors of bio-based adhesive compoundss, one or more compositions comprising one or more methacrylate compounds bearing catechol and/or quinone moieties, or a mixture thereof. With preference, the one or more precursors of the adhesive compound are one or more precursors of bio-based adhesive compounds.

For example, the one or more precursors of bio-based adhesive compounds are selected from L-dopamine, L-tyrosine, L-phenylalanine, L-phenylehtylamine, more preferably L-dopamine.

### The One or More Natural Fibres Materials

Advantageously, the one or more natural fibres materials comprise at least 30 wt. % of cellulose based on the total weight of the one or more natural fibres materials, preferably at least 40 wt. %, more preferably at least 50 wt. %, or at least 60 wt. %.

Advantageously, the one or more natural fibres materials are selected from the group comprising flax, kenaf, hemp, jute, ramie, nettle, pineapple leaf, sisal, date palm, cotton, coconut fibre, coconut coir, kapok, bamboo, abaca, fique, wood, bagasse or a mixture thereof. With preference, one natural fibres material is flax.

For example, the one or more natural fibres materials are selected from woven fabrics, nonwoven fabrics, cords, yarns, or any mixture thereof.

For example, the one or more natural fibres materials have a morphology which is unidirectional, bi-directional or tri-directional. With preference, the one or more natural fibres materials have a morphology which is unidirectional.

### Further Preferred Features of the Method

For example, said step (e) is carried out by vacuum-assisted resin infusion moulding (VARIM). Advantageously, said step (e) is carried out in presence of one or more peroxides. For example, the one or more peroxides are selected from benzoyl peroxide, tert-butyl peroxide, di(4-tert-butylcyclohexyl) peroxydicarbonate, dilauroyl peroxide, di-tert-butyl peroxide, tetramethylbutyl peroxy-2-ethylhexanoate, tert-amyl-2-ethylhexyl monoperoxycarbonate.

For example, said polymer matrix provided at step (d) is or comprises one or more thermoplastic resins, or one or more thermoset resins, or one or more vitrimers; with preference, one or more thermoplastic resins.

According to a second aspect, the disclosure relates to a composite material comprising a polymer matrix and at least one natural fibres material, remarkable in that the composite material has a composite porosity fraction of at most 0.080% as determined by micro-computed X-Ray tomography, preferably of at most 0.075%, more preferably of at most 0.060%, even more preferably of at most 0.055%.

Advantageously, the one or more natural fibres material are one or more adhesive-treated natural fibres materials. Such one or more adhesive-treated natural fibres materials are hydrophobic and/or present an external surface with a contact angle superior to 90° and/or inferior to 150°.

One or more of the following features further advantageously define the composite material of the second aspect:
The composite material is produced according to the method defined in first aspect.
The composite material is a laminate composite material.
The one or more natural fibres materials are present in an amount ranging between 20 wt. % and 80 wt. % of the total weight of the composite material as determined by a weighing method, preferably between 30 wt. % and 70 wt. %.
The composite material presents cross-sections which show an interphase region between the polymer matrix and the one or more natural fibres materials as evidenced by atomic force microscopy, the interphase region having a thickness ranging between nm and 500 nm as determined by atomic force microscopy, preferably between 50 nm and 450 nm, more preferably between 100 nm and 400 nm, even more preferably between 150 nm and 350 nm, most preferably between 200 nm and 300 nm.
The composite material is a laminate composite material. With preference, the laminate composite material has an interlaminar shear strength (ILSS) of at least 21 MPa as determined in accordance with ISO14130, more preferably of at least 30 MPa. With preference, the laminate composite material has an interfacial shear strength (IFSS) of at least 21.2 MPa as determined in accordance with a single-fibre pull-out test, more preferably of at least 25.0 MPa.

According to a third aspect, the present disclosure relates to the use of a composite material as defined in the second aspect as one structural component of a vehicle.

According to a fourth aspect, the present disclosure relates to the use of a composite material as defined in the second aspect as one structural component of a sport equipment.

According to a fifth aspect, the present disclosure relates to the use of a composite material as defined in the second aspect as one structural component of a wind turbine.

### DESCRIPTION OF THE FIGURE

FIG. 1 is an image taken by atomic force microscopy of the composite material of the present disclosure. The image is taken at the interphase region between the polymeric resin of Elium® and the natural flax fibres, namely on the cross-section of the composite material.

FIG. 2 is a diagram of the free surface energy (γₛ) of the flax in function of the dopamine (i.e., a precursor of an adhesive compound) concentration.

FIG. 3 is a diagram of the free surface energy (γₛ) of the flax in function of the poly(ethylene)imine (PEI) (i.e., a polyelectrolyte) concentration.

FIG. 4 is a diagram of the free surface energy (γₛ) of the flax in function of the poly(ethylene)imine (PEI) molar mass.

FIG. 5 is a diagram of the free surface energy (γₛ) of the flax in function of the pH of the polymerization conditions of the step of applying an adhesive compound onto said one or more natural fibres materials to form one or more adhesive-treated natural fibres materials (step (b) of the method).

FIG. 6 indicates the free surface energy (γₛ) of the flax without cleaning step before step (b) and with a cleaning step before step (b).

### DETAILED DESCRIPTION

For the disclosure, the following definitions are given:

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all integer numbers and, where appropriate, fractions subsumed within that range (e.g., 1 to 5 can include 1, 2, 3, 4, 5 when referring to, for example, a number of elements, and can also include 1.5, 2, 2.75 and 3.80, when referring to, for example, measurements). The recitation of endpoints also includes the recited endpoint values themselves (e.g., from 1.0 to 5.0 includes both 1.0 and 5.0). Any numerical range recited herein is intended to include all sub-ranges subsumed therein. Decitex (dtex) is a metric unit, mainly used for continuous filament yarn, and defined as the mass in gram per 10,000 m. For instance, 440 dtex means 440 g per 10,000 m fiber/yarn. 1 kilotex=10 000 decitex (1 ktex=10 000 dtex).

The “warp direction” in a fabric is the direction given by the long yarn that runs vertically up and down the roll of the fabric.

The “weft direction” in a fabric is the direction given by the yarn that passes horizontally across the fabric roll and that is generally shorter than the long yarn that is used vertically.

The particular features, structures, characteristics or embodiments may be combined in any suitable manner, as would be apparent to a person skilled in the art from this disclosure, in one or more embodiments.

The disclosure relates to a method for producing a composite material comprising a polymer matrix and at least one natural fibres material, said method is remarkable in that it comprises the following steps:
a) providing one or more natural fibres materials;
b) applying an adhesive compound onto said one or more natural fibres materials under polymerization conditions to form one or more adhesive-treated natural fibres materials;
d) providing a polymer matrix; and
e) manufacturing a composite material with said polymer matrix and said one or more adhesive-treated natural fibres materials;
   wherein step (b) comprises providing an aqueous solution of one or more precursors of the adhesive compound and at least one polyelectrolyte, and dipping the one or more natural fibres materials into said aqueous solution.

Optionally, step (c) of washing and/or drying said one or more adhesive-treated natural fibres materials can be performed after step (b) and before step (d).

The one or more polyelectrolytes used during the coating of the one or more natural fibres materials are charge-bearing polymers. The one or more polyelectrolytes serve to improve the polymerization of the adhesive compound on the one or more natural fibres materials since they may form cross-links in the polymer structure. Their attachment on the surface of the one or more natural fibres materials may disturb the proceedings of the polymerization of the one or more precursors of the adhesive compound. Overall, this leads to a grainy adhesive structure that is coated around the one or more natural fibres materials because smaller aggregates of the adhesive compound that are more homogenous with respect their size are formed. Composite material with low porosity fraction are thus obtained through the method of the present disclosure.

Step (b) is preferably carried out under alkaline conditions, for example at a pH ranging between 7.8 and 9.0, or between 8.0 and 9.0, more preferably ranging between 8.0 and 8.7 and even more preferably ranging between 8.0 and 8.5.

The one or more polyelectrolytes have advantageously a molecular weight ranging between 300 g/mol and 1500 g/mol, preferably between 350 g/mol and 900 g/mol, more preferably between 400 g/mol and 800 g/mol, even more preferably between 450 g/mol and 750 g/mol, most preferably between 500 g/mol and 700 g/mol. For example, the one or more polyelectrolytes are selected from the group comprising poly(ethylene)imine (PEI), poly(acrylic acid) (PAA), poly(methacrylic acid) (PMMA), poly(allylamine hydrochloride), poly(acrylamide-2-methyl-propane sulfonate), poly(3-sulfopropyl methacrylate), poly(styrene sulfonate), poly(N—N—N-trimethyl-2-methacryloyl ethyl ammonium bromide), poly(vinyl sulphate), poly(diallyl dimethylammonium chloride), poly(4-vinyl-N-methylpridinium iodide), sulfonated-polyetherketone, sulfonated-polyetheretherketone, sulfonated-polyetheretherketoneketon, esulfonated-polyetherketoneketone, sulfonated polyetherketoneetherketoneketone, or a mixture thereof. With preference, one polyelectrolyte is poly(ethylene)imine (PEI).

For example, the polyelectrolyte can be linear, branched or dendrimeric, preferably branched.

The one or more precursors of adhesive compound can be selected for example from the group comprising one or more precursors of bio-based adhesive compound, one or more compositions comprising one or more methacrylate compounds bearing catechol and/or quinone moieties, or a mixture thereof. With preference, the one or more precursors of the adhesive compound are one or more precursors of bio-based adhesive compound, such as those selected from L-dopamine, L-tyrosine, L-phenylalanine, L-phenylehtylamine. More preferably, L-dopamine is chosen as the precursor of the adhesive compound, since its large availability.

For example, the concentration of the one or more precursors of the adhesive compound is ranging between 0.5 g/L and 7.0 g/L of the aqueous solution, preferably between 0.5 g/L and 3.0 g/L, more preferably between 0.5 g/L and 2.5 g/L, even more preferably between 1.0 g/L and 2.5 g/L. Indeed, at those preferred concentration ranging between 0.5 g/L and 3.0 g/L, the dispersive component of the free surface energy is minimized (i.e., below 15%) while the polar component of the free surface energy is maximized, indication a better interaction between the one or more adhesive-treated natural fibres materials and the liquid polymer resin forming the polymer matrix.

Advantageously, the concentration of the one or more polyectrolytes is ranging between 0.50 g/L and 5.0 g/L, more preferably between 0.75 g/L and 3.0 g/L of the aqueous solution, even more preferably between 0.75 g/L and 2.0 g/L, most preferably between 0.75 g/L and 1.5 g/L and/or the one or more polyelectrolytes are present in said aqueous solution so that the ratio between the one or more precurosrs of an adhesive compound and the one or more polyelectrolytes is raning between 1.0 to 3.0, preferably between 1.5 and 2.5.

The polymerization of the one or more precursors of an adhesive compound into the adhesive compound along with the one or more polyelectrolytes can be carried out at a temperature ranging between 15° C. and 90° C., preferably between 20° C. and 85° C., more preferably between 25° C. and 80° C.; and/or during a time ranging between 10 minutes and 10 hours, or between 15 minutes and 9 hours. The polymerization can be induced by an oxidant. For example, the polymerization can be carried out in presence of one or more oxidants. For example, the one or more oxidants are one or more selected from air, oxygen, CuSO₄, sodium periodate, ammonium peroxodisulfate or a mixture thereof.

The polymerisation can be performed under stirring conditions. It is also an advantage that the one or more natural fibres materials are dried before step (b).

To enhance the adhesion between the polymer matrix and the one or more natural fibres materials, not only the one or more natural fibres materials will be treated by applying an adhesive grainy structure comprising both at least one polyelectrolyte and one or more adhesive compounds onto their external surface but also, they will be cleaned for improving the adhesion of the adhesive grainy structure. This step allows for increasing the free surface energy of the adhesive-treated natural fibres materials, while keeping the dispersive component of the free surface energy low (i.e., below 15%) and the polar component of the free surface energy high. It is preferable that the method further comprises the step of cleaning the one or more natural fibres materials provided at step (a) before step (b) with a basic solution, notably by dipping the one or more natural fibres materials provided at step (a) into the basic solution, for example during a time ranging between 1 hour and 4 hours, or between 1.5 hours and 3.5 hours and/or at room temperature, namely at a temperature ranging between 15° C. and 30° C., or between 20° C. and 25° C.

For example, the step of cleaning is a mercerisation step made in accordance with ASTM D1695.

For example, the basic solution used for performing the cleaning step on the one or more natural fibres materials provided at step (a) before step (b) can have a pH of at least 10.0, or preferably of at least 10.5, or more preferably of at least 11.0. For example, the basic solution can have a pH ranging between 10.0 and 14.0, preferably between 10.5 and 13.5, or between 11.0 and 13.0.

For example, the basic solution comprises one or more alkali agents at a concentration ranging between 0.25 wt. % and 30.00 wt. % of the total weight of the basic solution, preferably between 0.50 wt. % and 25.00 wt. %, more preferably between 0.75 wt. % and 20.00 wt. %, even more preferably between 1.00 wt. % and 15.00 wt. %.

For example, the basic solution comprises one or more alkali agents selected from NaOH, KOH, LiOH, Ca(OH)₂, NH₄OH, or a mixture thereof, preferably one alkali agent is NaOH.

With preference, the method further comprises the step of drying the one or more natural fibres materials after the cleaning step and before step (b).

### About the One or More Natural Fibres Materials Provided at Step (a).

The one or more natural fibres materials can comprise at least 30 wt. % of cellulose based on the total weight of the one or more natural fibres materials, preferably at least 40 wt. %, more preferably at least 50 wt. %, or at least 60 wt. %. Advantageously, the one or more natural fibres materials can be selected from the group comprising flax, kenaf, hemp, jute, ramie, nettle, pineapple leaf, sisal, date palm, cotton, coconut fibre, coconut coir, kapok, bamboo, abaca, fique, wood, bagasse or a mixture thereof. With preference, one natural fibres material is flax.

For example, the one or more natural fibres materials can be selected from woven fabrics, nonwoven fabrics, twisted fabrics or any mixture thereof.

For example, the one or more natural fibres materials have a morphology which is unidirectional, bi-directional or tri-directional. With preference, the one or more natural fibres materials have a morphology which is unidirectional.

The manufacturing of the composite material itself can be carried out by vacuum-assisted resin infusion moulding (VARIM), preferably by using one or more peroxides to initiate the infusion moulding. The one or more peroxides can thus be mixed with the polymer matrix in an amount ranging between 0.5 wt. % and 5 wt. % based on the total weight of the polymer matrix, or between 0. 1 wt. % and 4 wt. %, or between 1 wt. % and 3 wt. %. For example, the one or more peroxides are selected from benzoyl peroxide, tert-butyl peroxide, di(4-tert-butylcyclohexyl) peroxydicarbonate, dilauroyl peroxide, di-tert-butyl peroxide, tetramethylbutyl peroxy-2-ethylhexanoate, tert-amyl-2-ethylhexyl monoperoxycarbonate, preferably benzoyl peroxide.

For example, the polymer matrix provided in step (d) can be or comprise one or more thermoplastic resins, or one or more thermoset resins, or one or more vitrimers; with preference, one or more thermoplastic resins.

For example, one or more thermoplastic resins can be one or more resins selected from poly(L-lactide) (PLA) resins, acrylic resins (e.g., poly(methyl methacrylate) (PMMA)) polypropylene (PP) resins, polyphtalamide (PPA) resins, polyetheretherketone (PEEK) resins, phenylene polysulfur (PPS) resins, polyamide-imide (PAI) resins, polyetherimide (PEI) resins, polyarylamide (PAA) resins, polyamide (PA) resins (e.g., polyamide 6 and/or polyamide 6-6; preferably, polyamide 6) or any mixtures thereof; with preference, one or more resins selected from poly(L-lactide) (PLA) resins, acrylic resins (e.g., poly(methyl methacrylate) (PMMA)), polyamide (PA) resins (e.g., polyamide 6 and/or polyamide 6-6; preferably, polyamide 6) or any mixtures thereof; more preferably, one or more resins selected from acrylic resins (e.g., poly(methyl methacrylate) (PMMA)).

For example, one or more thermoset resins can be one or more resins selected for unsaturated polyester resins, polyurethane resins, vinyl ester resins, polyepoxyde resins, epoxy resins, phenolic resins, bismaleimide resins, or any mixtures thereof.

For example, one or more vitrimers can be one or more vitrimerized non-biorenewable resins (e.g., epoxy, polyester, polyimine, elastomer) or vitrimers synthesized from biorenewable sources (examples of biorenewable sources are aromatics or aliphatic precursors). For example, in the case of vitrimerized non-biorenewable resins, conventional resins are modified by adding one or more catalysts to create dynamic bonds.

The present disclosure thus relates to a composite material comprising a polymer matrix and at least one natural fibres material, remarkable in that the composite material has a low composite porosity fraction, namely a composite porosity fraction of at most 0.080% as determined by micro-computed X-Ray tomography, preferably of at most 0.075%, more preferably of at most 0.060%, even more preferably of at most 0.055%.

With preference, such composite material is produced by applying the above-described process.

Advantageously, the one or more natural fibres material are one or more adhesive-treated natural fibres materials. Such one or more adhesive-treated natural fibres materials are hydrophobic and/or present an external surface with a contact angle superior to 90° and/or inferior to 150°.

The one or more natural fibres materials are advantageously present in an amount ranging between 20 wt. % and 80 wt. % of the total weight of the composite material as determined by a weighing method, preferably between 30 wt. % and 70 wt. %, more preferably between 40 wt. % and 60 wt. %.

For example, the composite material presents cross-sections which show an interphase region between the polymer matrix and the one or more natural fibres materials as evidenced by atomic force microscopy, the interphase region having a thickness ranging between 20 nm and 500 nm as determined by atomic force microscopy, preferably between 50 nm and 450 nm, more preferably between 100 nm and 400 nm, even more preferably between 150 nm and 350 nm, most preferably between 200 nm and 300 nm. In other words, the composite material shows three regions as evidenced by atomic force microscopy, a first region being the polymer matrix, a third region being the one or more natural fibres materials and a second region being between the first region and the third region, said second region having a thickness ranging between 20 nm and 500 nm as determined by atomic force microscopy, preferably between 50 nm and 450 nm, more preferably between 100 nm and 400 nm, even more preferably between 150 nm and 350 nm, most preferably between 200 nm and 300 nm.

The composite material is preferably a laminate composite material. This is because it is preferred that the one or more natural fibres materials provided at step (a) of the process have a morphology which is unidirectional. With preference, the laminate composite material has an interlaminar shear strength (ILSS) of at least 21 MPa as determined in accordance with ISO14130, or at least 22 MPa, or at least 23 MPa, or at least 24 MPa, or at least 25 MPa, or at least 26 MPa, or at least 27 MPa, or at least 28 MPa, or at least 29 MPa, more preferably of at least 30 MPa, or at least 31 MPa. The ILSS is a measurement of the resistance (i.e., bending test) between one natural fibre and the polymer matrix.

With preference, the laminate composite material has an interfacial shear strength (IFSS) of at least 21.2 MPa as determined in accordance with a single-fibre pull-out test, or at least 21.3 MPa, or at least 21.4 MPa, or at least 21.5 MPa, or at least 22.0 MPa, or at least 22.5 MPa, or at least 23.0 MPa, or at least 23.5 MPa, or at least 24.0 MPa, or at least 24.5 MPa, more preferably of at least 25.0 MPa, or at least 25.1 MPa, or at least 25.2 MPa, or at least 25.3 MPa, or at least 25.4 MPa, or at least 25.5 MPa, or at least 26.0 MPa. The IFSS is a measurement of the mechanical resistance at the interphase region, namely at the region which is in between the polymer matrix and the one or more natural fibres. It allows quantifying the adhesion between both polymer matrix and the one or more natural fibres.

As the ILSS and/or the IFSS are relatively high, the composite materials of the present disclosure, for example the laminate composite materials of the present disclosure, have thus improved resistance and subsequently, their tendency to break is decreased. They can be for example used as one structural component of a vehicle, a sport equipment or a wind turbine.

Advantageously, the one or more natural fibres materials of the composite materials have an average cross-section aspect ratio of at most 1.55 as determined by scanning electron microscopy, preferably of at most 1.54.

For example, the free surface energy of the adhesive-treated natural fibres materials is maximized, while keeping the dispersive component of the free surface energy below 15%.

### Test and Determination Methods

### Micro-Computed X-Ray Tomography (μCT)

Micro-computed X-Ray tomography (μCT) was performed on a laboratory X-Ray cone-beam CT system EasyTom 160 fabricated by RX Solutions (Chavanod, France). The objective of this measurement was to get a 3D imaging of the internal structure of the Elium®-flax composite based on X-Ray absorption contrast (linked to material local density). Therefore, the influence of the different surface treatments of the flax was examined on the flax-polymer matrix interphase integrity. The composite samples were cut into 2 mm×2 mm×15 mm parallelepipeds and glued on graphite sticks as sample holders. The tomography scan was performed perpendicular to the sample's main axis. The main acquisition parameters are summarized in Table 1.

TABLE 1
Acquisition parameters for μCT imaging

| Acquisition parameter | Value | |
|---|---|---|
| Detector type | CCD | |
| Source-to-object distance (SOD) | 26 | mm |
| Source-to-detector distance (SDD) | 235 | mm |
| Voxel size | 1 | μm |
| X-ray source voltage | 60 | kV |
| Current | 200 | μA |
| Exposure per frame | 1.5 | s |

| Number of average frames | 3 |
|---|---|
| Rotation | 360° |
| Number of recorded images | 1120 |
| Acquisition time | 1 h 24 |

Once, all projections were acquired, the 3D volume reconstruction was achieved thanks to the software Xact64 (RX Solutions). First, a spot correction was used to remove any artefact due to potential sample movement during the acquisition. Then, a geometrical “Offset X” correction of several pixels was applied for accounting the horizontal shift of the focal spot projection position on the detector (due to sample stability towards x-rayₛ). Indeed, this defect was distinguished as a double edge visible on the Y slices. Later, ring artefacts were drastically attenuated by a “ring filter” option available in the reconstruction software. To this end, a mathematical correction is applied to smoothly modify each pixel value with a correction factor (20 px) to preserve edges as much as possible. Finally, reconstruction was achieved using the filtered back projection algorithm. For the quantification of the tomographic imaging, the commercial software Avizo (ThermoFisher, Waltham, MA, USA) was used for 3D image analysis. First, the scans were denoised using a median filter option, which is one of the most used approaches in the literature due to its simplicity and efficiency (parameters: 3D treatment, 26 neighbourhoods, 3 iterations). This method replaced the grey level of each pixel with the median value of the grey levels of a certain number of neighbour pixels. The volume intensity was segmented by taken intensity comprised between 0 (black) and typically 20000-25000, corresponding to the detection of the matrix (dark grey). The selected intensity corresponded to the voids. Insignificant small objects (the voids) below 20 pixels were eliminated (part of the noise and too small for an accurate morphological quantification). Last, the volume fraction of the voids was determined by the software for a sample volume of the order of 1 mm³.

### Owens-Wendt-Rabel-Kaelble (OWRK) Double-Liquid Method

The wettability of the one or more natural fibres materials was estimated by calculating its free surface energy (γₛ) that must be as high as possible to ensure a good interaction with the liquid polymer resin forming the polymer matrix. Ys was determined based on the Owens-Wendt-Rabel-Kaelble (OWRK) double-liquid method by measuring the contact angle of deionized water and diiodomethane (purity 99%, Sigma Aldrich, Saint Louis, MO, USA) droplets deposited onto the material surface.

Owens, Wendt, Rabel and Kaelble developed a two-component model to separate the interfacial tension according to the underlying interactions between the molecules. These interactions are defined as polar and dispersive interactions. The free surface energy of the solid is the sum of the two parts. The polar interactions arise due to the permanent dipole-permanent dipole interactions or Keesom forces. They are stronger and only exist in polar molecules. Dispersive components also known as London forces are weak and arise due to random fluctuations in the electron density in an electron cloud and hence lead to temporary/induced dipole interactions. For ensuring a good interaction between the one or more natural fibres materials and the liquid polymer resin forming the polymer matrix, it is required that the free surface energy is maximized and that the polar component of the free surface energy of the one or more natural fibres materials is high and that the dispersive component of the free surface energy of the one or more natural fibres materials is low. Typically, the dispersive component of the free surface energy should not exceed 15%. For those calculations, the values of 72.8 mN/m, 51.0 mN/m, and 21.8 mN/m, were respectively considered as liquid surface tension γ_{L}, polar component

$${γ}_{L}^{p}$$

and dispersive component

$${γ}_{L}^{p}$$

for deionized water.

The values of 50.8 mN/m, 2.3 mN/m, and 48.5 mN/m, were respectively considered as liquid surface tension γ_{L}, polar component

$${γ}_{L}^{p}$$

and dispersive component

$${γ}_{L}^{p}$$

for diiodomethane.

The tested free surface energy γ_{S}, polar component

$${γ}_{S}^{p}$$

and dispersive component

$${γ}_{S}^{d}$$

were calculated by solving the following equations for the two liquids:

$${γ}_{L} ( 1 + cos θ ) = 2 \sqrt{{γ}_{S}^{p} {γ}_{L}^{p}} + 2 \sqrt{{γ}_{S}^{d} {γ}_{L}^{d}} \qquad [ 1 ]$$

$${γ}_{S} = {γ}_{S}^{p} + {γ}_{S}^{d} \qquad [ 2 ]$$

where θ represents the measured contact angle.

A Dataphysics OCA 15 contact angle device (DataPhysics Instruments GmbH, Filderstadt, Germany) was utilized for the sessile drop testing, whereas a syringe pump was used to deliver 2-μL and 1-μL droplets of deionized water and diiodomethane, respectively. Flax fibres were tested as a function of the applied surface treatment. The contact angle θ was calculated from the captured image of the droplet after fitting its profile with a Laplace-Young model. For each case, three measurements were conducted.

### Atomic Force Microscopy (AFM)

Atomic force microscopy (AFM)imaging was conducted to observe the morphology of flax fabrics as a function of the treatment. In particular, the roughness was determined, as this parameter has an important effect on the interphase bonding with a polymer matrix. Measurements were done with an AFM model MFP-3D Infinity from Asylum Research (Oxford Instrument, Santa Barbara, CA, USA). All the images were recorded under ambient conditions (room temperature of 21±2° C. and relative humidity of about 50%) by using a standard cantilever holder for testing in air and fast force mapping (FFM) mode. The selected silicon tips had a nominal spring constant of 2 N/m and a nominal radius of 10 nm (reference AC240TS from Olympus). At least three representative areas were considered for the roughness calculations. Observation of the composite cross-section was also conducted to reveal the PDA coating onto the natural fibre. To this end, the sample cross section was polished using a cryo-ultramicrotome (Leica EM FC6) equipped with a diamond knife (cryo-diamond knife) 35°, whereas imaging was performed with the bimodal tapping mode to reveal elastic modulus variation. This is expected to facilitate the visualization of the PDA coating compared to the polymer matrix and the flax fibre, and hence to measure the thickness of the coating.

### Scanning Electron Microscopy (SEM)

The morphology of the composite cross-sections was observed by scanning electron microscopy (SEM) using an environmental machine Quanta FEG 200 (FEI, Eindhoven, The Netherlands). Samples were investigated with this technique without any conductive coating using the low vacuum mode (60 Pa of water pressure in the SEM chamber). Note that the composite sections were cut from the composite coupons, embedded in a mounting resin and polished until a mirror-like finish was achieved. To this end, an automatic polishing machine Tegramin-25 from Struers (Ballerup, Denmark) was used.

### X-Ray Photoelectron Spectroscopy (XPS)

The surface elemental composition of flax fabrics was determined by X-ray photoelectron spectroscopy (XPS) using a Kratos Axis Ultra DLD photoelectron spectrometer (Manchester, UK). The measurements were conducted with the monochromatic Al K radiation (1486.6 eV) and an X-ray power of 150 W. Note that a charge neutralizer was utilized because the tested samples were not electrically-conductive, yielding an energy resolution of 0.8 eV for the narrow scans. The area of analysis was adjusted to 700 μm×300 μm for each case, and all the analyses were done with a 0° take-off angle with respect to the surface normal. In general, an analysis depth of about 10 nm can be considered with XPS. The gathered data were processed with the software CasaXPS software (version 2.3.22) to determine the elemental composition. In particular, the binding energy scale of all the spectra was corrected by positioning the main C—(C, H) components at 284.9 eV. Then, the peak fit of the spectra was conducted by using symmetrical Gaussian-Lorentzian (70-30) functions, and the elemental composition was calculated taking into account the relative sensitivity factors from the spectrometer's library.

### Interfacial Adhesion

The interfacial adhesion between flax and the polymer matrix was determined by interlaminar shear strength (ILSS) and interfacial shear strength (IFSS) testing:

### Interlaminar Shear Strength (ILSS)

ILSS is determined in accordance with ISO14130.

For ILSS measurements, the short beam specimen (SBS) of dimensions 20 mm (length/)×10 mm (width b)×3.5 mm (thickness h) was cut from the composite coupons based on the standard ISO14130. To get information about interlaminar strength, and hence fibre-matrix interfacial strength participating in the interlamellar debonding process, the sample bending should be accompanied by horizontal shear failure mechanisms. In principle, the standard indicates a sample thickness of 2 mm to enhance horizontal failure and limit compression failure at the load application point (sample midpoint). It has been verified that the sample thickness h of 3.5 mm mainly conducts to horizontal shear failure. The samples were tested with a universal electro-mechanical testing machine Instron 5967 (Norwood, MA, USA) equipped with a 3-point bending system. The latter was configured with a loading nose having a radius of 5 mm, whereas the two supports had a radius of 2 mm and a span distance L of 10 mm. The testing was done at room temperature (21±2° C.) and relative humidity of 30% RH. The samples were loaded at a deflection rate of 1 mm/min. The flexural stress of at the sample midpoint was calculated based on the following equation (ASTM D790):

$${σ}_{f} = \frac{3 PL}{2 {bh}^{2}} \qquad [ 3 ]$$

where P is the load at a given point on the load-displacement curve. The flexural stress-deflection curves were reported for the different composites varying with the flax surface treatment, whereas the ILSS was determined as the flexural stress at the yield point. At least samples per case were tested to determine ILSS. Some optical microscopy images of some selected samples at the post-mortem state were recorded to visualize the potential failure mechanisms.

### Interfacial Shear Strength (IFSS)

IFSS measurements were done by single fibre-pull-out testing using a FAVIMAT+machine from Textechno (Mönchengladbach, Germany), equipped with a load cell of 210 cN. The following steps were done. First, the single fibre was tested with the FAVIMAT+system to determine its linear density and diameter d_{f}. Then, the single fibre was embedded within the polymer matrix with an applied embedding length of 90 μm (the effective embedding length lₑ was precisely measured). This step was done with the FIMABOND machine from Textechno (Mönchengladbach, Germany). In particular, the polymer resin was introduced in a crucible and then the fibre was precisely positioned and embedded in the centre of the polymer droplet. Afterwards, the resin was cured and the sample was carefully transferred again to the FAVIMAT+machine. The pull-out was done at a displacement rate of 0.1 mm/min and a temperature of 23° C. It is important to mention that it was not possible to embed flax fibre within Elium® resin because just after the introduction of the resin (mixed with the initiator) in the crucible, a solid skin instantaneously formed at the surface of the resin droplet making it impossible the penetration of the fibre within the matrix. This step was repeated by cooling the crucible during the resin introduction to avoid solid skin formation, but this issue was still present. So, it was decided to replace the Elium® resin with a thermoplastic grade of poly(methyl methacrylate) (PMMA) (reference Acrigel DH LE from Unigel Plasticos, Candeias, Brazil), considering that Elium® and this PMMA would exhibit a similar surface chemistry (both materials containing the methyl methacrylate monomer), and hence, a similar interaction with the flax fibre. The apparent IFSS (τₐₚₚ) was calculated from the maximum force fmax recorded on the force-displacement curve during the pull-out of the fibre, and the fibre characteristics d_{f} and lₑ:

$${τ}_{app} = \frac{{f}_{max}}{π {d}_{f} {l}_{e}} \qquad [ 4 ]$$

Tₐₚₚ corresponded to the normalized maximum force to the wetted area of the fibre, and was considered a qualitative method to estimate fibre-matrix adhesion, because it included both the stress needed to debond the fibre from the polymer matrix and the stress resulting from the fibre-matrix interfacial friction.

At least 15 fibres were tested per case, whereas only fibres with a diameter comprised between 15 μm and 30 μm were considered for the data evaluation.

### Examples

The embodiments of the present disclosure will be better understood by looking at the different examples below.

### Fibre Surface Treatments

The flax material was in the form of a unidirectional fabric provided by the company Dehondt Composites (Port-Jérôme-sur-Seine, France) under the reference Nattex UD 400. This fabric was characterized by a width of 1 m, thickness of 0.8 mm and density of 400 g/m². The reinforcement effect of the fabrics is ensured by yarns in the warp direction with a mass in gram of one meter of 2.6 ktex and a density of 380 g/m². In the weft direction of the fabrics, few yarns (density of 20 g/m²) are present as their only functionality is ensuring the handling of the fabrics. Based on the supplier safety datasheet and the review article of Bledzki A. K., et al, entitled “Composite reinforced with cellulose based fibres” (Prog. Polym. Sci, 1999, 24, 221-274) a representative composition of the flax fibres, based on the total weight of the flax fibres, is cellulose (64.1 wt. %), hemicellulose (16.7 wt. %), pectin (1.8 wt. %), lignin (2 wt. %), wax (1.5 wt. %), water-soluble (3.9 wt. %), and water (10 wt. %). The surface of the as-received flax fibres was untreated. The surface treatments were performed on samples with the dimensions 10 cm×10 cm that were carefully cut from the fabrics. These samples were subsequently used to prepare the UD 4-ply composites.

The alkali treatment of the flax was done as follows: a 3 wt. % NaOH solution was prepared from pellets of NaOH (Carl Roth, Karlsruhe, Germany) with a purity ≥98%. The samples of fabrics were dipped for 2 hours in this solution at room temperature (21±2° C.). After this step, the samples were washed several times with distilled water until a neutral pH was reached and finally samples were dried in an oven at 60° C. for 4 h.

The polydopamine (PDA) nanocoating deposition on flax was conducted without or after alkali treatment. First, dopamine solutions with concentrations varying between 0.5 and 6.3 g/L were prepared by dissolving dopamine hydrochloride (Sigma Aldrich, Steinheim, Germany) in a 1.2 g/L buffer solution of tris(hydroxymethyl)aminomethane (Euromedex, Strasbourg, France). The pH of the solution was then adjusted between 8 and 9 by adding a 1M solution of hydrochloric acid (Carl Roth, Karlsruhe, Germany). Then, poly(ethylene)imine (PEI) was added to the solution varying its concentration (from 0 to 4 g/L) and its molecular weight (600 g/mol and 1,200 g/mol). Flax fabrics samples were then immersed in the solution for 24 h at room temperature (21±2° C.) under stirring (150 rpm). During this period, dopamine polymerized in the presence of oxygen and was deposited onto flax samples. The color of the water solution changed from dark yellow (or orange without PEI) to black during the formation of polydopamine, whereas the pH decreased with time (typically from an initial value of 8.7 to 8.2 after 24 h of reaction). At the end of this step, the solution was washed several times with distilled water until the solution became clear to eliminate the PDA that was not deposited onto the flax. Finally, the coated flax fabrics samples were dried in an oven at 60° C. for 6 h.

### Composite Preparation

The laminate composites were prepared from the UD flax fabrics using vacuum-assisted resin infusion moulding (VARIM). To this end, the acrylic resin Elium® referenced RT 150 from Arkema (Lacq, France) was used, while the VARIM process was conducted on a conventional set-up adapted to small and flat composites plates (vacuum bag of several tens of centimeter on a flat glass substrate). Before the infusion, the fibre fabric samples were placed in an oven at 50° C. and 0.01 MPa for 24 h to remove moisture. 4 samples of dry UD flax fabrics were superposed in the vacuum bag to process one coupon of laminate composite (all the UD fabrics being oriented in the same direction). Before being introduced in the vacuum bag by infusion, 100 g of Elium® resin was mixed with 2 g of initiator (i.e., benzoyl peroxide) Once the fabrics were infused, the injection of the resin was stopped, and the composite coupons were left for 6 h in the vacuum bag to finalize the polymerization. The final thickness of the composite coupons was on average 3.5 mm. The one or more natural fibres materials are present in an amount ranging between 40 wt. % and 45 wt. % of the total weight of the composite material as determined by a weighing method.

The studied cases were named as follows:
Flax (as-received flax),
A-Flax (as-received flax after alkali treatment),
PDA-Flax (as-received flax after PDA treatment),
PDA/PEI-Flax (as-received flax after PDA treatment in the presence of PEI), and
PDA/PEI-A-Flax (A-Flax after PDA treatment in the presence of PEI).

### Characterization

Table 2 provides the atomic composition of the surface of the composite material as determined by XPS. As-received flax is mainly composed by cellulose, hemicellulose, lignin, wax and pectin. So, its surface atomic composition is dicated by the proportion of each of these components. The ratio O 1s/C of Flax is 0.25, much lower than the theoretical O 1s/C values of cellulose (0.83) and hemicellulose (0.82), indicating the surface composition of flax is probably dictated by an important fraction of components with a low ratio O 1s/C that could be lignin (0.30) or wax (0.12). After alkali treatement, an increase of oxygen and a decrease of carbon content is observed, given a ratio O 1s/C of 0.38 in the case of A-Flax. This finding indicates a decrease of the component having a low ratio O 1s/C that are lignin and wax, which is suitable to improve adhesion with a polymer resin. After PDA treatment, a weak increase of nitrogen content is noted indicating the presence of PDA at the surface of the fibre PDA-Flax. The ratio O 1s/C of PDA-Flax is close to the theoretical one of PDA (0.24 for PDA-Flax vs. 0.25 for PDA), whereas the ratio N 1s/C is much lower for PDA-Flax (0.03) vs. that of PDA (0.12). This could indicate an non-homogeneous covering of the flax by the PDA nanocoating. When PEI is used as polyelectrolyte for generating cross-links during PDA polymerization (cases PDA/PEI-Flax and PDA/PEI-A-Flax), the content of nitrogen significantly increases compared to the case PDA-Flax, demonstrating a more homogeneous covering of flax fibre with the PEI/PDA nanocoating. This result may be due to the presence of PEI that is expected to create cross-links during the polymerization of the adhesive compound (i.e., PDA), probably resulting in a more homogeneous size of adhesive compound grains on the natural fibres materials.

TABLE 2
Surface atomic composition determined by XPS analysis
(experimental and theoretical values)

| | Surface atomic composition | | | Surface atomic ratio | |
|---|---|---|---|---|---|
| | C 1s | N 1s | O 1s | O 1s/C | N 1s/C |
| | (%) | (%) | (%) | 1s (—) | 1s (—) |
| Flax | 77.5 | 1.9 | 19.2 | 0.25 | 0.02 |
| A-Flax | 64.0 | 1.5 | 24.0 | 0.38 | 0.02 |
| Cellulose* | 28.6 | — | 23.8 | 0.83 | — |
| Hemicellulose* | 28.9 | — | 23.7 | 0.82 | — |
| Lignin* | 40.0 | — | 12.0 | 0.30 | — |
| Wax* | 32.0 | — | 3.8 | 0.12 | — |
| Pectin* | 26.0 | — | 30.4 | 1.17 | — |
| PDA-Flax | 77.2 | 2.1 | 18.8 | 0.24 | 0.03 |
| Polydopamine* | 36.4 | 4.5 | 9.1 | 0.25 | 0.12 |
| PDA/PEI-Flax | 76.0 | 6.2 | 16.4 | 0.22 | 0.08 |
| PDA/PEI-A-Flax | 77.9 | 5.2 | 16.6 | 0.21 | 0.07 |
| PDA/PEI* | 34.6 | 5.8 | 7.7 | 0.22 | 0.17 |

*Theoretical value calculated from the monomer units or structural formulae (by considering (C₆H₁₀O₅)ₙ for the cellulose case, an approximative 50:50 mixture of pentosans (C₅H₈O₄)ₙ and hexosans (C₆H₁₀O₅)ₙ for the hemicellulose case [1], an approximative 33.3:33.3:33.3 mixture of p-coumaryl alcohol (C₉H₁₀O₂)ₙ, coniferyl alcohol (C₁₀H₁₂O₃)ₙ, and sinapyl alcohol (C₁₁H₁₄O₄)ₙ for the linin case [2], an approximate 50:50 mixture of C16 (CH₃(CH₂)₁₄COOH) and C18 (CH₃(CH₂)₁₆COOH) fatty acids as main wax components in flax straw for the wax case [3], D-galacturonic acid C₆H₁₀O₇ as the main component of pectin in flax for the pectin case [4], C₈H₁₁NO₂ for the polydopamine case, and a 66.6:33.3 mixture of dopamine C₈H₁₁NO₂ and polyethylenimine (C₂H₅N)ₙ for the polydopamine/polyethylenimine case).

* Theoretical value calculated from the monomer units or structural formulae (by considering (C₆H₁₀O₅)ₙ for the cellulose case, an approximative 50:50 mixture of pentosans (C₅H₈O₄)ₙ and hexosans (C₆H₁₀O₅)ₙ for the hemicellulose case [1], an approximative 33.3:33.3:33.3 mixture of p-coumaryl alcohol (C₉H₁₀O₂) n, coniferyl alcohol (C₁₀H₁₂₀₃) n, and sinapyl alcohol (C₁₁H₁₄O₄)ₙ for the lignin case [2], an approximative 50:50 mixture of C16 (CH₃(CH₂)₁₄COOH) and C18 (CH₃(CH₂)₁₆COOH) fatty acids as main wax components in flax straw for the wax case [3], D-galacturonic acid C₆H₁₀O₇ as the main component of pectin in flax for the pectin case [4], C₈H₁₁NO₂ for the polydopamine case, and a 66.6:33.3 mixture of dopamine C₈H₁₁NO₂ and polyethylenimine (C₂H₅N), for the polydopamine/polyethylenimine case).

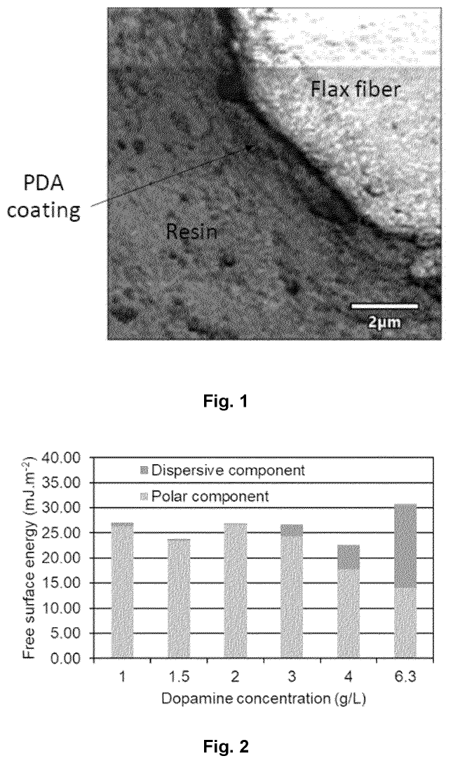

The thickness of the interphase region between the Elium® matrix and the flax fibres has been determined to be in average 250 nm. This has been determined by AFM imaging (elastic modulus contrast) of a composite of material comprising cleaned flax treated with PDA and PEI (PDA/PEI-A-Flax), shown in FIG. 1.

Table 3 provides the results of μCT achieved on the composite material.

TABLE 3
Determination of pore fraction by μCT testing

| Case | Pore fraction (%) |
|---|---|
| Flax | 0.193 |
| A-Flax | 0.084 |
| PDA-Flax | 0.098 |
| PDA/PEI-Flax | 0.070 |
| PDA/PEI-A-Flax | 0.054 |

Those results indicate that the composite material according to the present disclosure, namely comprising flax treated with both PDA and PEI, has a low porosity fraction of 0.070%. By conducting a cleaning step before the application of the adhesive compound around the natural fibres, it has been possible to obtain a composite material presenting a porosity fraction as low as 0.054%, indicating a strong strengthening of the structure of the composite material. Table 4 also indicates that without PEI, the composite material has rather a high porosity fraction, of 0.084% when the flax is merely cleaned and 0.098% when the flax is coated with the adhesive compound only.

Table 4 provides the aspect ratio and the average area of the flax fibres in the composite material.

TABLE 4
Determination of flax fibre aspect ratio and area in composite
by SEM analysis done on composite cross-sections

| | Average aspect | Average area |
|---|---|---|
| | ratio (with | (mm²) (with |
| Case | standard deviation) | standard deviation) |
| Flax | 1.70 ± 0.61 | 6.8E−04 ± 1.3E−03 |
| A-Flax | 1.57 ± 0.55 | 4.9E−04 ± 0.9E−03 |
| PDA-Flax | 1.56 ± 0.47 | 6.8E−04 ± 1.3E−03 |
| PDA/PEI-Flax | 1.55 ± 0.55 | 6.3E−04 ± 1.5E−03 |
| PDA/PEI-A-Flax | 1.53 ± 0.51 | 5.7E−04 ± 1.1E−03 |

Those results indicate that the composite material according to the present disclosure, namely comprising flax treated with both PDA and PEI, has a low aspect ratio of 1.55. By conducting a cleaning step before the application of the adhesive compound around the natural fibres, it has been possible to obtain a composite material presenting an aspect ratio as low as 1.53, indicating that the flax fibres form smaller and more round section, suitable to increase the interaction aera with the polymer matrix, and hence mechanical properties.

Table 5 provides the results of the interlaminar shear strength (ILSS) and interfacial shear strength (IFSS) tests performed on the composite material.

TABLE 5
Determination of IFSS and ILSS by mechanical testing

| | Interfacial | Interlaminar |
|---|---|---|
| | shear strength | shear strength |
| Case | (IFSS) (MPa) | (ILSS) (MPa) |
| Flax | 20.9 ± 4.8 | 18.5 ± 0.5 |
| A-Flax | 21.1 ± 3.8 | 20.4 ± 0.5 |
| PDA-Flax | 18.3 ± 1.4 | 19.0 ± 2.0 |
| PDA/PEI-Flax | 21.2 ± 4.9 | 24.2 ± 2.0 |
| PDA/PEI-A-Flax | 25.5 ± 5.7 | 30.2 ± 2.8 |

Those results indicate that the composite material according to the present disclosure, namely comprising flax treated with both PDA and PEI, has a high IFSS, namely of 21.2 MPa; and a high ILSS, namely of 24.2 MPa. By conducting a cleaning step before the application of the adhesive compound around the natural fibres, it has been possible to obtain a composite material presenting an IFSS as high as 25.5 MPa and an ILSS as high as 30.2 MPa.

FIG. 2 is a diagram of the free surface energy (γₛ) of the flax in function of the dopamine concentration (and at a constant pH of 8.5). This shows that when the concentration of the precursor of the adhesive compound (in this case, dopamine) is ranging between 1.0 g/L and 2.0 g/L, the free surface energy of the adhesive-treated natural fibre is maximized and the dispersive component of the free surface energy represents typically less than 15%, the best case being 2 g/L for which the dispersive component represents less than 1%.

FIG. 3 is a diagram of the free surface energy (γₛ) of the flax in function of the poly(ethylene)imine (PEI) concentration (at a constant concentration of the precursor of the adhesive compound equal to 2 g/L, with a constant molecular weight of PEI of 600 g/mol, and at a constant pH of 9). It has been shown that the optimized PEI concentration for which the free surface energy of the adhesive-treated natural is maximized and the dispersive component represents typically less than 15% corresponds to 1.0 g/L.

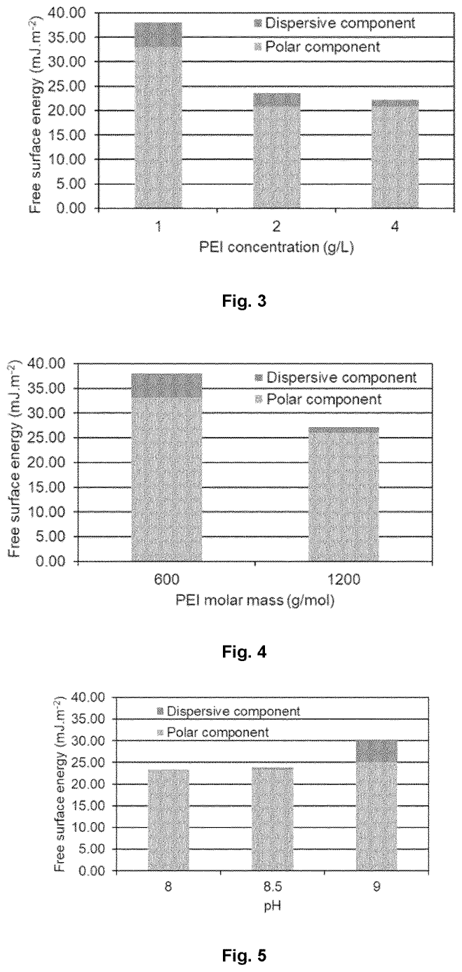

FIG. 4 is a diagram of the free surface energy (γₛ) of the flax in function of the poly(ethylene)imine (PEI) molar mass (at a constant concentration of the precursor of the adhesive compound equal to 2 g/L, with a constant PEI concentration of 1 g/L, and at a constant pH of 9) for which the free surface energy of the adhesive-treated natural fibre is maximized and the dispersive component represents typically less than 15% corresponds to 600 g/mol.

FIG. 5 is a diagram of the free surface energy (γₛ) of the flax in function of the pH of the polymerization conditions of the step of applying an adhesive compound (at a constant concentration of 1.5 g/L) onto said one or more natural fibres materials to form one or more adhesive-treated natural fibres materials (step (b) of the method). The free surface energy of the adhesive-treated natural fibre is maximized and the dispersive component represents typically less than 15% in the case of pH 8.5.

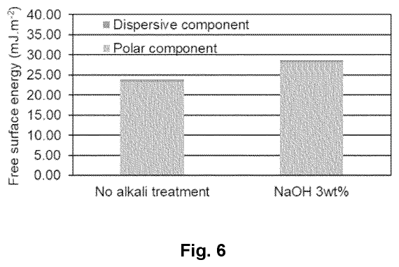

FIG. 6 indicates the free surface energy (γₛ) of the flax without a cleaning step before step (b) and with a cleaning step before step (b). It has thus been observed that the free surface energy of the flax increases upon the achievement of a cleaning step (in this specific case, with a basic solution comprising 3 wt. % of NaOH based on the total weight of the basic solution). As the whole free surface energy of the flax is increasing upon cleaning, and as the dispersive component stays weak, this is the confirmation that the cleaning of the one or more natural fibres materials provided at step (a) before step (b) with a basic solution offers a non-trivial advantage.

1. Method for producing a composite material comprising a polymer matrix and one or more natural fibres material said method is characterized in that it comprises the following steps:
a) providing one or more natural fibres materials;
b) applying an adhesive compound onto said one or more natural fibres materials under polymerization conditions to form one or more adhesive-treated natural fibres materials;
c) optionally washing and/or drying said one or more adhesive-treated natural fibres materials;
d) providing a polymer matrix; and
e) manufacturing a composite material with said polymer matrix and said one or more adhesive-treated natural fibres materials;
wherein step (b) comprises providing an aqueous solution of one or more precursors of the adhesive compound and at least one polyelectrolyte, and dipping the one or more natural fibres materials into said aqueous solution; and
wherein the method further comprises the step of cleaning the one or more natural fibres materials provided at step (a) before step (b) with a basic solution.

2. Method according to claim 1, characterized in that the polymerization conditions of step (b) comprise a pH ranging between 8 and 9.

3. Method according to claim 1, characterized in that the polymerization conditions of step (b) comprise a concentration of the one or more precursors of adhesive compound ranging between 0.5 g/L and 7.0 g/L of the aqueous solution.

4. Method according to claim 1, characterized in that the one or more polyelectrolytes are selected from the group comprising poly(ethylene)imine, poly(acrylic acid), poly(methacrylic acid), poly(allylamine hydrochloride), poly(acrylamide-2-methyl-propane sulfonate), poly(3-sulfopropyl methacrylate), poly(styrene sulfonate), poly(N—N—N-trimethyl-2-methacryloyl ethyl ammonium bromide), poly(vinyl sulphate), poly(diallyl dimethylammonium chloride), poly(4-vinyl-N-methylpridinium iodide), sulfonated-polyetherketone, sulfonated-polyetheretherketone, sulfonated-polyetheretherketoneketon, esulfonated-polyetherketoneketone, sulfonated polyetherketoneetherketoneketone, or a mixture thereof.

5. Method according to claim 4, characterized in that one polyelectrolyte is poly(ethylene)imine.

6. Method according to claim 1, characterized in that the concentration of the one or more polyectrolytes is ranging between 0.5 g/L and 5.0 g/L.

7. (canceled)

8. (canceled)

9. (canceled)

10. Method according to claim 1, characterized in that the one or more precursors of the adhesive compound are selected from the group comprising one or more precursors of bio-based adhesive compounds, one or more compositions comprising one or more methacrylate compounds bearing catechol and/or quinone moieties, or a mixture thereof.

11. Method according to claim 10, characterized in that the one or more precursors of adhesive compound are one or more precursors of bio-based adhesive compounds.

12. (canceled)

13. Method according to claim 1, characterized in that the one or more natural fibres materials are selected from the group comprising flax, kenaf, hemp, jute, ramie, nettle, pineapple leaf, sisal, date palm, cotton, coconut fibre, coconut coir, kapok, bamboo, abaca, fique, wood, bagasse or a mixture thereof.

14. Method according to claim 1, characterized in that the one or more natural fibres materials are selected from woven fabrics, nonwoven fabrics, twisted fabrics or any mixture thereof.

15. (canceled)

16. (canceled)

17. (canceled)

18. (canceled)

19. Method according to claim 1, characterized in that said polymer matrix provided at step (d) is or comprises one or more of liquid thermoplastic resins, one or more liquid thermoset resins or a mixture thereof.

20. Composite material comprising a polymer matrix and at least one natural fibres material, characterized in that the composite material has a composite porosity fraction of at most 0.080% as determined by micro-computed X-Ray tomography.

21. Composite material according to claim 20, characterized in that the composite material has a composite porosity fraction of at most 0.055% as determined by micro-computed X-Ray tomography.

22. Composite material according to claim 20-er 21, characterized in that the one or more natural fibres material are one or more adhesive-treated natural fibres materials.

23. Composite material according to claim 22, characterized in that said one or more adhesive-treated natural fibres materials are hydrophobic.

24. Composite material according to claim 20, characterized in that the one or more natural fibres materials are present in an amount ranging between 20 wt. % and 80 wt. % of the total weight of the composite material as determined by a weighing method.

25. Compoiste material according to claim 20, characterized in that the composite material shows an interphase region between the polymer matrix and the one or more natural fibres materials as evidenced by atomic force microscopy, the interphase region having a thickness ranging between 20 nm and 500 nm as determined by atomic force microscopy.

26. Composite material according to claim 20, characterized in that the composite material is a laminate composite material.

27. Composite material according to claim 26, characterized in that the laminate composite material has an interlaminar shear strength (ILSS) of at least 21 MPa as determined in accordance with ISO14130.

28. Composite material according to claim 26, characterized in that the laminate composite material has an interfacial shear strength (IFSS) of at least 21.2 MPa as determined in accordance with a single-fibre pull-out test.

29. (canceled)

30. (canceled)

31. (canceled)
